(19) United States
(12) Patent Application Publication
(10) Pub. No.: US 2017/0185729 A1
(43) Pub. Date: Jun. 29, 2017

(54) METHODS AND SYSTEMS OF A HYPERBOLIC-DIRAC-NET-BASED BIOINGINE PLATFORM AND ENSEMBLE OF APPLICATIONS

(71) Applicants: Srinidhi Boray, Potomac Falls, VA (US); Barry Robson, Grand cayman, KY (US)

(72) Inventors: Srinidhi Boray, Potomac Falls, VA (US); Barry Robson, Grand cayman, KY (US)

(21) Appl. No.: 15/356,533

(22) Filed: Nov. 18, 2016

Related U.S. Application Data
(60) Provisional application No. 62/256,856, filed on Nov. 18, 2015.

(51) Int. Cl. G06F 19/00; G06N 7/00; G06N 99/00

(52) U.S. Cl. CPC G06F 19/345; G06N 99/005; G06N 7/005

(57) ABSTRACT

In one example aspect, a method obtains a file system of a virtual machine. The virtual machine comprises a plurality of applications. The plurality of applications are started through an initialization system when the virtual machine is initialized. The method captures a set of contents of the file system of the virtual machine. The method captures a metadata of the file system of the virtual machine. The method captures a state of file system of virtual machine. The method converts the plurality of applications deployed in the virtual machine into a set of containers by creating a separate container image for each application of the plurality of applications deployed in the virtual machine. Each container comprises an application packaging medium and is built based on a container specification. The container specification is derived from the set of contents of the file system of the virtual machine, metadata of the file system of the virtual machine, and the state of file system of virtual machine. The method includes using the container specification to generate a second virtual machine.

### CROSS-REFERENCE TO RELATED APPLICATIONS

This application is a claims priority from U.S. Provisional Patent Application No. 62/256,856, filed on 18 Nov. 2015. These applications are hereby incorporated by reference in their entirety.

### BACKGROUND

1. Field

This application relates generally to data analysis, knowledge extraction, computational reasoning and visualization delivered on a High-Performance Cloud Computing (HPC) Platform, and more particularly to methods and systems of a hyperbolic-Dirac-net (HDN) based the BioIngine platform and ensemble of applications.

2. Related Art

Many healthcare organizations have generated large clinical data sets. For example, these large clinical data sets can reside within a large patient Health Information Exchange (HIE). An organization may seek to analyze these large data sets to increase their healthcare management efficiency and also importantly extract evidences in terms of health ecosystem knowledge for improving clinical efficacy and thereby reducing medical errors.

At the same time, there has been a revolution in data science. The new HDN based data science can be applied for analytics and knowledge synthesis to develop into bio-statistical based Inductive reasoning by Probabilistic Inference. Accordingly, solutions are desired that addresses critical areas in both scientific and technical aspects of these issues. For example, there are healthcare interoperability challenges for delivering semantically relevant medical knowledge both at patient health (e.g. clinical—functional) and population health level (e.g. an Accountable Care Organization—systemic).

### BRIEF SUMMARY OF THE INVENTION

In one example aspect, a method obtains a file system of a virtual machine. The virtual machine comprises a plurality of applications. The plurality of applications are started through an initialization system when the virtual machine is initialized. The plurality of applications achieves the interoperability among the data generated from the diverse systems and applications. The invention comprises novel combinations of the following discussed innovative features in the methods as applied to the virtual machine. The method captures a set of contents of the file system of the virtual machine. The contents of the file system of the virtual machine that are important as input to further processing can be considered as of two kinds of source data commonly called structured (or semi-structured) and unstructured data. The method captures metadata of the file system of the virtual machine. The method captures a state of the file system of virtual machine. The data sets captured in the plurality of applications results into Data Lake. The method also scans the World Wide Web (WWW), relevant published medical data bases and medical journals and extracts the context specific medical knowledge as a probabilistic rules and statements. The method extracts knowledge from sources of the above two main kinds; namely the structured and the unstructured, in order to assist humans in reasoning by performing automated reasoning. Whenever possible this reasoning is probabilistic in order to take account of uncertainty, credibility, or scope as extent of applicability of knowledge collected. An innovative feature of the system described is that a query by a person such as a physician, which may in the form of certain standard medical measures such as relative risk or odds ratios or as much more elaborate query structures called inference nets, can drive the selection of required information from the repository of knowledge already extracted or drive extraction of further knowledge where required. Representing the input query for certain standard measures or as a more elaborate inference net or some blend of the two in a common intuitive form is also an innovative feature. The invention comprises novel combinations of these innovative features in the virtual machine. Structured or semi-structured data such as electronic patient records or collections of data from human subjects are seen as a repository called the Data Lake, or are collated into an intermediate form and collection convenient for processing that is also called the Data Lake. This Data Lake is used as input and analyzed by such techniques that belong to the discipline called data mining. In the present case, this is of a kind that leads to probabilistic representation of the knowledge extracted. The method then uses this knowledge in automated reasoning such as for decision support by physicians, health workers, and researchers. The approach is applicable to the discipline of evidence based medicine amongst others. The data sets captured in the plurality of applications results in a store of knowledge called the Knowledge Representation Store (KRS) or Semantic Lake. The method also scans the World Wide Web (WWW), relevant published medical data bases and medical journals and extracts the context specific medical knowledge as a probabilistic rules and statements. A statement is in this case a statement about the world, an expression of knowledge about the world analogous to a sentence in a natural language, with the probability associated with it as degree of truth, credibility, or scope of applicability of that statement. The source analyzed here is of the type commonly termed unstructured data, and is typically natural language text, such as authoritative text written by medical experts and displayed on web pages or files linked to web pages. The content of these pages, further processed, can also be considered as a kind of Data Lake. The knowledge extracted by the method from structured (or semi-structured) and unstructured Data Lakes is stored in the KRS repository or Semantic Lake. The knowledge extracted from structured (or semi-structured) and unstructured data is in a similar canonical form, i.e. similar format and ontological representation, so that it can coexist mixed freely and be used together in several kinds of automated reasoning processes and variations on them. The form extracted from unstructured data can be considered as a cruder form awaiting curation by a human expert or automated agent, but it can often be used for automated reasoning in the uncurated form. Such use is also a method of testing and helping curate the extracted knowledge. The canonical form of knowledge representation in the Knowledge Representation Store or Semantic Lake as a repository of extracted knowledge represents a form that computers can readily read and write. The general idea of such a repository and regular form of some kind is not novel, but novel methods may relate to its generation and use, which may involve innovation in the detailed form of the statements of knowledge. In particular, the present invention relates in part to novel use of the concept of probabilities attached to such statements. There is a relation with the so-called “semantic triples” on the Semantic Web, a worldwide effort to link data and knowledge on the Internet, not just web pages and people. However, semantic triples always comprise only two things and a relationship, and importantly they are not associated with probabilities as degrees of truth, credibility or scope in any extensive or agreed manner. The method employs probabilistic inference and computational reasoning against the semantic lake delivering tacit medical knowledge to the proposed medical diagnostic inquiry. Particularly the probabilistic inference and means of generating probabilities employ high order multivariate techniques of estimation. This avoids the undesirable effects of an inevitable combinatorial explosion when there are relationships involving many factors or data items such as medical observations and measurements. The method achieves a transformation of structured and unstructured contents of the data lake into semantic lake (KRS); probabilistic inference, probabilistic computational reasoning such as based on a multiple choice medical exam setting for medical students and also allows for curating the medical knowledge by relevant subject matter experts, in this case the medical doctors and physicians. This is done by employing a set of containers by creating a separate container image for each application of the plurality of applications deployed in the virtual machine. Each container comprises an application-packaging medium and is built based on a container specification. The container specification is derived from the set of contents of the file system of the virtual machine, metadata of the file system of the virtual machine, and the state of file system of virtual machine. The method includes using the container specification to generate a second virtual machine. Importantly the set of containers are implemented on High Performance Cloud Computing architecture.

### BRIEF DESCRIPTION OF THE DRAWINGS

FIG. 1 illustrates an example BioIngine platform for delivering MARPLE implemented on High Performance Cloud Computing Platform as a business capability, according to some embodiments.

The BioIngine platform of FIG. 1 can implement process as provide in FIG. 2, according to some embodiments.

FIG. 3 illustrates an example QEXL approach, according to some embodiments.

FIG. 4 illustrates an example inference engine, according to some embodiments.

FIG. 5 illustrates an example probabilistic computations module, according to some embodiments.

FIG. 6 illustrates an example deterministic computations module, according to some embodiments.

FIG. 7 illustrates an example Semantic lake/knowledge representation store/hyperbolic Dirac net, according to some embodiments.

FIG. 8 depicts an exemplary computing system that can be configured to perform any one of the processes provided herein.

FIG. 9 is a block diagram of a sample-computing environment that can be utilized to implement various embodiments.

The Figures described above are a representative set, and are not an exhaustive with respect to embodying the invention.

### DESCRIPTION

Disclosed are a system, method, and article of hyperbolic-Dirac-net-based BioIngine platform and ensemble of applications. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the Illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided. It is noted that additional example definitions for some example embodiments are provided below the definitions section as well.

Bayes Net can be a probabilistic graphical model that represents a set of random variables and their conditional dependencies via a directed acyclic graph (DAG). One of the limitations of the technique Bayes Net (BN) a Bayesian derivative, which is the gold standard, is that it is confined to a probability network that is a directed acyclic graph (DAG).

Big data can describe data sets so large or complex that traditional data processing applications are inadequate. Challenges include analysis, capture, data variability, data volume, data velocity, data curation, search, sharing, storage, transfer, visualization, and information privacy.

High Performance Cloud Computing can involve deploying groups of remote servers and/or software networks that allow centralized or federated data storage and online access to computer services or resources. These groups of remote serves and/or software networks can be a collection of remote computing services. Generally, there are three classification of the Cloud computing services; Infrastructure as a Service (IaaS), Platform as a Service (PaaS) and Software as a Service (SaaS).

Cognitive computing is the simulation of human thought and systematic reasoning processes in a computerized model. Cognitive computing involves self-learning systems both adaptive and generative that use data mining, deterministic and probabilistic computations, automated statistical reasoning, linguistic semantics, machine learning, pattern recognition, and natural language processing; and all these brought into a scheme of artificial intelligence to mimic the way the human brain works.

Continuity-of-care (COC) can, in the context of a health-care patient, where the most important artifact is just one patient's electronic health record (EHR), or a subset of information on it, exchanged between stakeholders (healthcare providers, authorized players) such as the patient, physician and pharmacist. In one example, COC in this report can apply when stakeholders are in different institutions networks of care such as accountable care organizations, and even different countries.

Hyperbolic Dirac Nets (HDN) are inference networks capable of overcoming the limitations imposed by Bayesian Nets (and statistics) and creating generative models richly expressing the “Phenomenon Of Interest” (POI) by the action of expressions containing binding variables. An HDN can be a general graph, bidirectional and with cycles. Hyperbolic Dirac Net (HDN), “Dirac” relates to use of Paul A. M. Dirac's view of quantum mechanics (QM). QM is not only a standard system for representing probabilistic observation and inference from it in physics, but also it manages and even promotes concepts like reversibility and cycles. The significance of “hyperbolic” is that it relates to a particular type of imaginary number rediscovered by Dirac. Dirac notation entities, Q-UEL tags, and the analogous building blocks of an HDN all have complex probabilities better described as probability amplitudes.

Machine learning can include algorithms that can learn supervised and unsupervised from and make predictions on data. Said algorithms can operate by building a model from example inputs in order to make data-driven predictions or decisions, rather than following strictly static program instructions.

Mobile device can be a smart phone, tablet computer, wearable computer (e.g. a smart watch, a head-mounted display computing system, etc.). In one example, a mobile device can be a small computing device, typically small enough to be handheld having a display screen with touch input and/or a miniature keyboard.

Natural language processing (NLP) is a field of computer science, artificial intelligence, and computational linguistics concerned with the interactions between computers and human (natural) languages.

Neural Network can be a computational approach which is based on a large collection of neural units loosely modeling as a closer depiction to the way brain solves problems with large clusters of biological neurons connected by axons. Each neural unit can be connected with many others, and links can be enforcing or inhibitory in their effect on the activation state of connected neural units. Each individual neural unit may have a summation function, which combines the values of all its inputs together. There may be a threshold function or limiting function on each connection and on the unit itself such that it must surpass it before it can propagate to other neurons.

Prolog is a general purpose logic programming language associated with artificial intelligence and computational linguistics. Prolog belongs to the Symbolic Programming Language variety. Besides Prolog, LISP and The Wolfram Language are other popular symbolic programming languages.

Quantum-Universal Exchange Language (Q-UEL) for medicine, based on generating medical knowledge by data mining many patient records and authoritative medical text using XML-like tags as artifacts.

Semantic Web is an extension of the Web through standards. The Semantic Web provides a common framework that allows data to be shared and reused across application, enterprise, and community boundaries.

Multivariate Cognitive Architecture (MCA) can be as follows. In the light of ever increasing system complexity introduced by high dimensionality in the data and stalked by uncertainty; MCA can advance the order of the system design by the employ of semantics driven architecture. Such that, it develops into systemic capability for mining and employing tacit knowledge, as ascertained by experience and evidence that needed by a decision support system addressing a highly complex system.

Probabilistic Ontology can be a knowledge representation approach specifically employed while modeling a large complex system riddled with uncertainty. Science and medicine number amongst many systems of knowledge in which certainty is not always guaranteed. Others, to which solutions to best practice in uncertainty would be extensible, include business and product development, effective quality control, employee innovativeness and technical vitality, marketing, investment and financial, military, national security, meteorology, pharmaceutical development, and agriculture domains. Uncertainty spans the following continuum: observation→data→information→knowledge→inference→decision→risk between Information and knowledge lie the important domains of probabilistic ontology (PO).

The QEXL Approach: the nature and purpose of the current invention should also be seen in a market context as a solution driven by significant pressing needs to aid healthcare. QEXL stands for “Quantum Exchange Languages” and is a Systems Thinking driven technique to explore routes to interoperability that have been designed with the intension of developing “Go To Market” solutions for Healthcare Big Data interoperability applications requiring integration between Payor, Provider, Health Management (Hospitals), Pharma etc. There is a preference for use of the long established standards and principles of theoretical physics and quantum mechanics where those are genuinely appropriate and helpful to probabilistic representation of observations, knowledge, and reasoning outside of physics. It is intended as a solution where the systemic complexities tethering on the “edge of chaos” pose enormous challenges in achieving interoperability owing to existence of plethora of healthcare system integration standards and management of the unstructured data in addition to structured data ingested from diverse sources. After a significant amount of thought and research, its favored solution at this time, with only a few very specialized exceptions for special cases, is the Q-UEL or “Quantum Exchange Language” with which the current method and BioIngine are compatible and which can ultimately embrace other challenges and domains. Irrespective of Q-UEL's merits as a Universal Exchange Language, within the QEXL program or research, it has proven the best solution so far to designing architectures that that require integration of diverse data, information, knowledge and insight. The particular feature of Q-UEL as opposed to other solutions is the importance of probability or extent of truth in regard to statements of knowledge, and above all the adoption of the Dirac Notation and algebra. While other QEXL solutions could provide a plausible general structure, the Q-UEL solution seems most elegant in that its canonical representations of knowledge can be understood by physicist knowing the Dirac notation, and any human reasonably qualified in science and medicine, alike, because of its natural mapping to natural human language. In general, the QEXL Approach targets for the creation of Tacit Knowledge Sets by inductive techniques and probabilistic inference from the diverse sets of data characterized by volume, velocity and variability. In general, also, the QEXL Approach facilitates algorithmic driven Proactive Public Health Management, while rendering business models achieving Accountable Care Organization more effective.

The QEXL approach is an integrative multivariate declarative cognitive architecture proposition to develop Probabilistic Ontology driven Big Data applications creating interoperability among Healthcare systems. Where, it is imperative to develop architecture that enable systemic capabilities such as Evidence Based Medicine, Pharmacognomics, biologics etc. while also creating opportunities for studies such as Complex Adaptive System (CAS). Such an approach is vital to develop ecosystem as a response to mitigate the Healthcare systemic complexities. Especially CAS studies makes it possible to integrate both macro aspects (such as epidemiology) related to Efficient Healthcare Management Outcomes; and micro aspects (such as Evidence Based Medicine and Pharmacogenomics that helps achieve medicine personalization) achieving Efficacy in the Healthcare delivery, to help achieve systemic integrity.

Complex Adaptive System (CAS) can be a collection of individual agents with freedom to act in ways that are not always totally predictable and whose actions are interconnected. Examples can include a colony of termites, the financial market, and a surgical team. CAS is not the same as chaos theory. Chaos theory can be a subset of complexity science. Complexity science offers a powerful new approach—beyond merely looking at clinical processes and the skills of healthcare professionals.

A ‘PICO’ approach is commonly used to formulate research questions. The acronym PICO stands for Population (Participants), Intervention (or Exposure for observational studies), Comparator and Outcomes. PICO is a popular format for formulating medical diagnosis questions seeking evidence-based diagnosis. Generally, PICO format based “well-built” question should include four parts, referred to as PICO that identify the patient problem or population (P), intervention (I), comparison (C) and outcome(s) (O). 1. The first step in developing a well-built question is to identify the patient problem or population.

Evidence based Medicine (EBM) can use medical evidence to effectively guide medical practice is an important skill for all physicians to learn. The purpose of this article is to understand how to ask and evaluate questions of diagnosis, and then apply this knowledge to the new diagnostic test of CT colonography to demonstrate its applicability. Evidence-based medicine is an effective strategy for finding, evaluating, and critically appraising diagnostic tests, treatment and application. This skill will help physicians interpret and explain the medical information patients read or hear about.

Exemplary Systems

A BioIngine platform can be implemented using multivariate cognitive architecture. The BioIngine platform can utilize cognitive computing to resolve ontological un-decidability (e.g. a fleeting problem, etc.) by employing probabilistic ontology (e.g. determine a solution, etc.). In some embodiments, the BioIngine platform can implement various business capabilities.

An example business capability includes a Medical Automated Reasoning Programming Language Environment (MARPLE). MARPLE can employ an algorithm based on Q-UEL/HDN. MARPLE can be utilized for various evidence-based medical applications. MARPLE can be used to provide a bio-statistically laid-out representation of a health ecosystem.

The BioIngine platform can be used for both patient health and/or population health (e.g. Epidemiology) analytics. The BioIngine platform can use a range of bio-statistical methods (e.g. descriptive statistics, inferential statistics, leading into evidence driven medical reasoning. The BioIngine platform can be used to transforms large clinical data sets generated by interoperability architectures, such as in Health Information Exchange (HIE) into a semantic lake. The semantic lake can represent a health ecosystem that is more amenable to bio-statistical reasoning and knowledge representation. As introduced in the summary, a Knowledge Representation Store (KRS), sometimes popularly called a Semantic Lake, are examples of repositories of knowledge represented in some canonical form that computers can readily read and write. Again, the general idea of such is not novel, but rather novel methods may relate to its generation and use, which may involve innovation in the detailed form of the statement.

The BioIngine platform can use large clinical data sets and/or reside within a large patient Health Information Exchange (HIE). The BioIngine platform can implement knowledge extraction from large data sets (e.g. both structured and unstructured data). The BioIngine platform can be based in a cognitive computing platform. The BioIngine platform can implement univariate regression. The BioIngine platform can implement correlation clustering. The BioIngine platform can implement multivariate analysis (e.g. as the complexity of a problem increases. The BioIngine platform can implement multivariate regression analysis.

The BioIngine platform can implement a Hyperbolic Dirac Net (e.g. with an inverse or dual Bayesian technique, etc.). The BioIngine platform can implement an artificial-intelligence driven reasoning capability MARPLE. This can be used on both structured and unstructured data sets. Furthermore, it will be designed to be customized for EBM driven “Point of Care” and “Care Planning” productized user experience. The BioIngine platform can implement a comprehensive bio-statistical reasoning experience in an application that blends descriptive and inferential statistical studies The BioIngine platform can provide a high-performance cloud-computing platform that delivers a health-care large-data analytics capability. This capability can be derived from an ensemble of bio-statistical computations. The automated bio-statistical reasoning can a combination of deterministic and probabilistic methods employed against both structured and unstructured large data sets leading into cognitive reasoning.

The BioIngine platform can employ algorithmic approach based on a Hyperbolic Dirac Net (HDN). The HDN can enable the creation of inference nets that are a general graph (GG), including cyclic paths. HDN can be an advanced version of Bayesian Inferential Statistics. HON can make use of the Bayes equation (as opposed to a traditional Bayes Net, paradoxically which does not). Bayes Nets can be considered as simple special cases or subsets of HDNs. An HDN need not be confined to a Directed Acyclic Graph as is the traditional Bayes Net. An HDN can be a General Graph. The inference nets, represented as HDN can be created employing Quantum Universal Exchange Language (Q-UEL). Q-UEL can transform the input data sets considered to be in the state of information into knowledge presentation.

A Hyperbolic Dirac Net (HDN) can be a Bayesian model and a probabilistic general graph model that includes cause and effect as players of equal importance. An HDN can a type of bidirectional network implied in quantum mechanics and the real world. In medicine, an HDN can enable determination of a most probable cause and/or etiology, as well as, a most probable outcome. An HDN can include and/or goes beyond a Bayes Network. An HDN may not constrain interactions. An HDN may contain cyclic paths in graphs representing the probabilistic relationships between all things (e.g. states, events, observations, measurements etc.). In addition, however, the relationships between subject and object need not be of a simple condition or “if” nature, like verbs of action. An HD can define a probabilistic semantics. An HDN can also evolve under logical, grammatical, definitional and/or other relationships. An HDN, in its larger context, a model of the nature of natural language, and human reasoning based on it, that takes account of uncertainty. An HDN can be an inference net.

A Quantum Universal Exchange Language (Q-UEL) can be a notational language designed deriving from the Dirac Notation. Q-UEL can be used to extract information from data mining structured sources and natural language text on the Internet, and to represent knowledge probabilistically, and so to build HDNs interactively or automatically. While Dirac Notation (e.g. braket, bra-ket, bracket notation, etc) can defines the framework for Quantum Mechanics, Q-UEL can define framework for probabilistic semantics. The BioIngine approach can thus reflect the nature of probabilistic knowledge in the real world.

As noted above, Q-UEL and the HDN can enable more elaborate relationships than mere conditional dependencies, as a probabilistic semantics analogous to natural human language but with a more detailed sense of probability. To identify the things and their relationships that are important and provide the required probabilities, a BioIngine system can scout the large complex data of both structured and also information of unstructured textual character. The BioIngine system can treats initial raw extracted knowledge rather in the manner of potentially erroneous or ambiguous prior knowledge, and validated and curated knowledge as posterior knowledge, and enables the refinement of knowledge extracted from authoritative scientific texts into an intuitive canonical “deep structure” mental-algebraic form. The BioIngine system can include an environment that interacts with standard medical record systems. The BioIngine system/platform can be implemented on a Wolfram Knowledge-based Programming environment that is designed and implemented on The Wolfram Language, Symbolic Programming Language designed and developed by Wolfram Research. Accordingly, the BioIngine system can use Symbolic Programming to implement the Notational Alegbra underlying the Dirac Notation that results into hyperbolic-Dirac-net and be integrated into rich MATHEMATICA libraries. The BioIngine system can implement comprehensive biostatistics computations that are both descriptive and inferential and based on HDN. The BioIngine system can be invoked by an API such that it can be integrated with a variety of end-users systems (e.g. a variety of risk factors, etc.). The BioIngine system can consider the risk factors and/or other predictions that are based not just on a few simple probabilities but use inference nets based on the general graph.

It is noted that, in some example embodiments, Q-UEL and HDN can be inter-convertible. Q-UEL can be used for a web-based universal exchange and inference language for healthcare and biomedicine. Q-UEL can be used for the following, inter alia: a) Medical data mining b) Capturing data from Laboratory Information Managements Systems (UMS), c) Content exchange between various established forms of Electronic Health Record (EHR) and Health Information Exchange (HIE). Q-UEL can be a system of XML-like tags each of which has algebraic force by representing probability duals appropriate to probabilistic computations in semantics. Q-UEL can be used directly to build inference programs, inference nets, and inference engines. Q-UEL can comprise both tags as probabilistic statements and tags as metastatments or rules that manipulate one or more statements in logical and definitional reasoning. Q-UEL can be a type of Universal Exchange language (UEL). Dirac notation on which Q-UEL is based, can be used to represent observations and measurements and drawing inference from them, a description that also essentially covers data bases and a major use of them, e.g. at least a major part of the domain for which Q-UEL had to provide. An example HDN illustrating use and advantages of these principles is concerned with self, joint and particularly condition probabilities, though these collectively may have associative, categorical, causal, and certain relative value interpretations. This HDN may be seen as a kind of extension to the Bayes Net (BN), except that the BN may be confined to a Directed Acyclic Graph (DAG) and the HDN is not.

Employment of Q-UEL for Medical Automated Reasoning Programing Language Environment (MARPLE) is now discussed. MARPLE can be a suite of Q-UEL software applications (e.g. using Q-UEL tags for communications and reasoning operations, etc.) for more advanced reasoning. MARPLE can use the HDN paradigm that started with the basic HDN, but then extend it to probabilistic semantics. Networks of interacting match-and-edit instructions as heterogonous automata, acting rather like enzymes and other proteins in an intracellular protein interaction network, could facilitate functionality. Q-UEL metastatements can also act on each other in a comparable way, via interchange with the Semantic Web (SW) or Q-UEL's counterpart to the SW.

Example BioIngine Platform Architecture

BioIngine platform architecture 100 can applies an intuitive integrative multivariate declarative cognitive architecture proposition to develop a probabilistic ontology. The probabilistic ontology can be drive ‘big data’ applications. This can create interoperability among various enterprise healthcare systems (e.g. computerized healthcare systems and databases, etc.). BioIngine platform architecture 100 can enable systemic capabilities such as, inter alia: evidence-based medicine, pharmacogenomics (e.g. study of the role of genetics in drug response), biologics, and the like. BioIngine platform architecture 100 can also create opportunities for studies such as, inter alia, Complex Adaptive System (CAS). In this way, BioIngine platform architecture 100 can be used in responses to mitigate various healthcare systemic complexities. For example, CAS studies be used to integrate both macro aspects (such as epidemiology) related to Efficient Healthcare Management Outcomes. In another example CAS studies can be used to integrate micro aspects (e.g. evidence-based medicine, pharmacogenomics, etc. that can be used for personalization of medicine, etc.). In this way, BioIngine platform architecture 100 can be used to achieve efficacy in healthcare delivery systems and logistics, as well as, systemic integrity. In an example, QEXL approach. In some embodiments, Q-UEL can be used as a programming language to implement BioIngine platform 100.

The BioIngine platform architecture 100 can implement artificial partitions-of-work. The BioIngine platform architecture 100 can employ architecturally Probabilistic Inference (PI). Data architecture for the Inference Engine (IE) can be designed to be cooperative. Software robots can be created while PI and IE interact. The inference knowledge gained by the PI and IE can provide rules for solvers (e.g. software robots, etc.) to self-compile and conduct queries etc. The software robots can be designed and programmed to do the remaining coding required to perform as solvers. The software robots can be provided with well-formed instructions as well as well-formed queries. Once inferences are formed, different “what-if” questions can be asked.

It is as if having acquired knowledge, Phenomenon-Of-Interest (POI) is in a better state to explore what a meaning. HDNs are inference networks capable of overcoming the limitations imposed by Bayesian Nets (and statistics) and creating generative models richly expressing the POI by the action of expressions containing binding variables. This can be implemented as an Expert System that is analogous to Prolog data and Prolog programs that act upon the data (e.g. probabilistic Prolog, etc.). A Bayes Net can be implemented as a static directed acyclic conditional probability graph is a subset of the Dirac Net as a static or dynamic general bidirectional graph with generalized logic and relationship operators (e.g. empowered by the mathematical machinery of Dirac's quantum mechanics).

In some embodiments, the BioIngine platform is currently targeted to the healthcare and pharmaceutical domains where recognition of uncertainty can be performed in observations, measurements and predictions, and probabilities underlying a variety of medical metrics. It is noted that, in other embodiments, the scope of application of the BioIngine platform can be more general as well. The BioIngine platform can have a generic multivariate architecture for complex system characterized by Probabilistic Ontology that employs a generative order will model “POI” facilitating creation of “communities of interest” by self-regulation in diverse domains of interest, requiring integrative of disciplines to create complex studies.

Example BioIngine Platform System

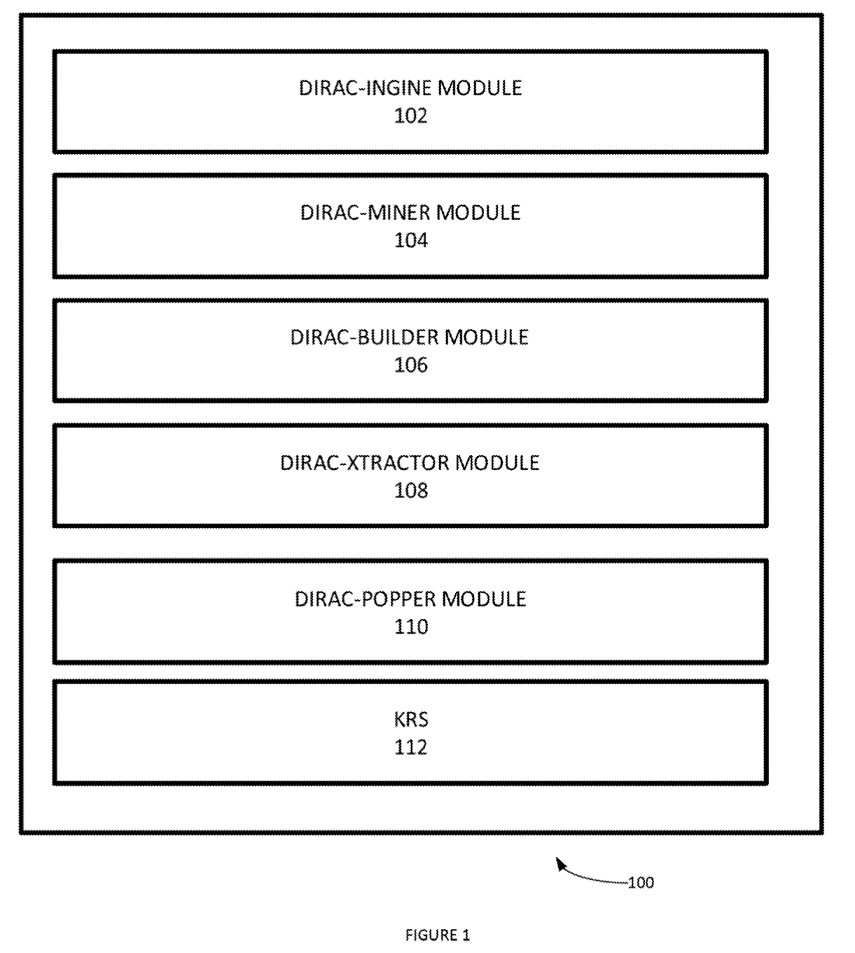

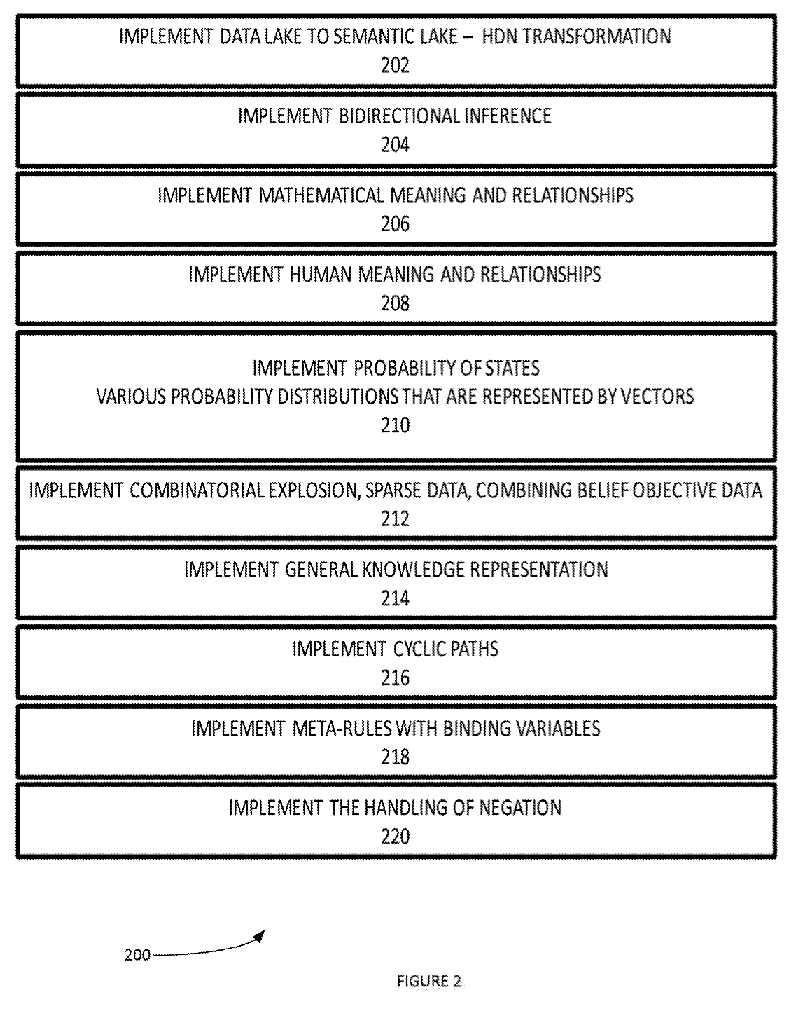

FIG. 1 illustrates an example BioIngine platform 100 for delivering MARPLE as a business capability, according to some embodiments. Dirac-ingine module 102 can implement a data science approach that embraces Dirac notation (e.g. bra-ket notation). Dirac-ingine module 102 can implement non-predicated machine learning. Dirac-ingine module 102 can employ Q-UEL. Dirac-ingine module 102 can generate hyperbolic Dirac nets (HDN) (e.g. as general graphs, etc.). An HDN can include Bayes nets (e.g. as a directed acyclic graph(s), etc.) option as a subset.

Dirac-miner module 104 can be a machine-learning (e.g. Supervised machine learning and/or unsupervised machine learning) tool. Dirac-miner module 104 can implement unsupervised structured data mining. Dirac-miner module 104 can employ Dirac notation to extract knowledge (e.g. as semantic triple store, etc.) from large data sets. These data sets can have issues with uncertainty. The extracted medical knowledge can be represented in terms of semantic triples or multiples. They can be represented as HDN graphs. They can be placed in a knowledge representation store (KRS) 110.

Dirac-Builder, a HDN based inference tool module 106 can implement an HDN-based inference mechanism from KRS 110. Dirac-inference tool module 106 can be an inference tool. Dirac-inference tool module 106 can be based on a complex query. This can be an ensemble of variables and measurements. Dirac-inference tool module 106 can scan the HDN based semantic triple store, KRS 110, etc. Dirac-inference tool module 106 can locate the missing statements and/or paths that connect them. In this way, the overall, questions, statements between, and each answer in turn can represent an HDN.

Dirac-xtractor module 108 can implement unsupervised unstructured data mining. Dirac-xtractor module 108 can include an unsupervised-unstructured web searching tool. Using the unsupervised-unstructured web-searching tool, the Dirac-xtractor module 108 can employ Dirac notation having a strong relationship with the semantic structure used in the semantic web. The unsupervised-unstructured web-searching tool can generate many millions of statements of knowledge. The knowledge can be extracted as semantic triples. The Dirac-xtractor module 108 can place said semantic multiples in the KRS 110.

It is further noted that BioIngine platform 100 can utilize HDN to advance beyond Bayesian estimate methods and/or Bayes Net-based method. BioIngine platform 100 can implement process 200 as provide in FIG. 2, according to some embodiments. In step 202 of the process, the BioIngine platform 100 can implement HDN transformation of the Data Lake into semantic Lake based on HDN method.

In step 204 of process, BioIngine platform 100 can implement bidirectional inference (e.g. etiologies as well as outcomes). In step 204 of process, BioIngine platform 100 can implement intrinsic treatment of coherence (e.g. as Bayes Rule, etc.).

In step 206 of process, BioIngine platform 100 can implement Mathematical meaning and relationships—This relates to the role of the fundamental entities used in the method as not only canonical representations of knowledge but algebraic objects that can interact to produce new knowledge, and particular so in regard to use of the Dirac Notation first developed in physics, and the algebra it implies. In this perspective, relationships are seen as operators, often expressible as matrices. For example, in <X and Y|O|Z>, in Dirac notation <X and Y| is an example of a row vector (that physicists would more typically write as <X, Y|), O is an operator that can be expressed as a matrix, and |Z> is a column vector. In addition, according to Dirac notation and algebra, <X and Y|O|Z> is a result of multiplying these in that order which is a single scalar value. When discussing the theory behind our method, O is typically replaced by R to emphasize that it always represents some kind of relationship.

In step 208 of process, BioIngine platform 100 can implement Human meaning, relationships—the Interpretation of our representation of knowledge as algebraic objects not only in terms of physics but in terms of everyday life including medicine, and mapping to the way we express simple ideas and relationships, e.g. respectively as noun phrases and verbal or prepositional phrases. For example, <Jack and Jill|‘went up’|the hill> is a valid algebraic object and also a sentence in English, albeit delimited to show the use of the Dirac notation.

In step 210 of process, BioIngine platform 100 can implement Probability of States—In physics, the parts analogous to noun phrases such as <X and Y| and |Z> above are called state vectors analogous to states in the rest of physics and science. They are really vectors of probability values, akin to probability distributions, and the product such as <X and Y|Z>, which we can often read as <X and Y|if|Z>, and very often the above kind of product<X and Y|O|Z>, have a single value. It may be a probability, but it is typically a representation of a probability as a dual of probability values called the probability dual. The first probability in the dual correspond to the way we read the statement like a sentence, as in <X and Y|if|Z> and the second like a sentence as <Z|if|X and Y>, or the first as say <X and Y|O|Z> and the second as <Z|O|X and YZ>, i.e. we say the dual comprise the probability of the statement read by a human as give, and the second with subject and object expressions interchanged. The dual represents a complex value, i.e. a number with an imaginary part. In our approach, dual of any kinds of values {P, Q} represents the complex number ½[P+Q]+½h[P−Q] where h is the hyperbolic imaginary numbers such that hh=+1.

In step 212 of process, BioIngine platform 100 can implement Combinatorial Explosion, Sparse Data, Combining Belief and Objective Data—This represents a method that our approach uses to produce the probability values used above, based on a so-called zeta theory. Data mining data with many factors involved generates a combinatorial explosion of possible relationships or associations and hence a vast number of probabilities and probabilistic or information measures that these imply. It also means that there will be little data to evaluate the more complicated ones, even if we have, for example, many millions of patient records to data mine. We may say that there are low observed frequencies of observation. However they may be bolstered by addition of virtual frequencies that represent prior belief, general knowledge, or earlier or other studies. The behavior of probability values with data including those in probability duals also relates to the inference process itself. It implies probabilities that it are more consistent with the way probabilities should be used in inference networks when inference networks are, as is commonly the case, purely or largely multiplicative and seek to estimate complicated probabilities for which observed frequencies are very low or zero. When observed and virtual frequencies approach zero, the probability implied by zeta theory approaches one. This means that a new knowledge elements as a probability or probability dual will have no effect when introduced into an inference network if we have no data or knowledge concerning it. It is consistent with information theory by I=−log(P)=0 when P=1, and with the philosophy of Karl Popper that statements of knowledge are really initially assertions that await potential refutation by potentially increasingly observing more and exceptions. Equivalently, probabilities about knowledge of which we have in practice no knowledge, and which hence are omitted, are as if present with probability one. The impossible or absurd are also represented by probability one, For example, the second probability in the dual for <Jack and Jill|‘went up’|the hill>, which relates to the probability of the statement that “The hill went up Jack and Jill”, would normally be 1.

In step 214 of process, BioIngine platform 100 can implement General Knowledge Representation—As indicated above, knowledge representation and use of it is an essential aspect and purpose of the method, based on affinity to the Dirac notation and algebra. However, the assertion is that knowledge can in general be represented this way, in the manner of a “mathemization” of natural langue such as English. By reference to Dirac's notation and algebra, and in particular as applied in particle physics, our mathematical entities as statements of knowledge can be embedded in others to produce rich and complicated nested, tree-graph structures similar to those seen in the parsing of a natural language sentence into its grammatical parts. Moreover the includes structures such as “Jack thinks that Jill thinks that they should go up the hill”.

In step 216 of process, BioIngine platform 100 can implement cyclic paths. The cyclical paths can fall out naturally from the BioIngine platform, and do not require iteration. It is noted that BioIngine platform 100 is not confined to AND logic. It is noted that BioIngine platform 100 is not confined to conditional probabilities. BioIngine platform 100 can implement relators and/or operators in a symbolical manner. However, the relators and/or operators can be implemented with probabilities, matrices and/or algorithms. In step 208 of process, BioIngine platform 100 can implement various probability distributions that are represented by vectors.

In step 218 of process, BioIngine platform 100 can implement meta-rules with binding variables. The meta-rules can be implemented to generate new rules and evolve old rules. Meta-rules can also be used to define words from simpler vocabularies. In step 212 of process, BioIngine platform 100 can implement the handling of negation and, when there are double negation forms, etc., the conversion to canonical forms. In step 214 of process, BioIngine platform 100 can Implement reconciliation into one ‘rule of rules’ that overlap in Information content and/or are semantically equivalent. This can include the reconciliation of the various probabilities.

In step 220 of process, the BioIngine platform 100 can implement handling of negation. Negation is not fundamentally confined to this step, and can take several forms whenever a negative statement is introduced to give a fuller and fairer balance of evidence for or against something, rather than just extract a probability or estimate a complicate probability as an inference network. In the method, inclusion of negation as Information about alternatives could simply be seen as the comparison of the probability of having a particular blood pressure compared with different alternative blood pressures. Such probability distributions can be represented in the method by vectors imply a contrary or alternative “not” state as the set of all alternative states to a specified one of interest. However, an even simpler approach that is a feature of the BioIngine is that while entering a probability as part of the net is as a value to be multiplied into the net (the default), it can also be divided, added, or subtracted. For example, one could be concerned with probabilities concerned with evidence for predicting occurrence of heart attack within 10 years divided by probabilities concerned with evidence that a heart attack will not occur in 10 years. In such cases one is said to be dealing with odds (probability ratios such as likelihood ratios and predictive odds). The method also allows subtracting evidence for alternatives which relates to certain measures used in evidence based medicine and epidemiology such as those called absolute risk reduction.

More generally, BioIngine platform 100 can utilize a Q-UEL method to advance PI to deal with structured and unstructured data that cannot be resolved by normalized codes, standards alone. BioIngine platform 100 can employ advancement in math, progressed Q-UEL and/or HDN to apply unsupervised machine learning techniques. Also this allowed for emergence of newer architecture technique for designing ‘Big Data’ based Cognitive Computing, which is Non-Predicated. This means time to market in designing, developing and implementing complex IT systems. Overcomes the laborious traditional object oriented documentation; such as presently being pursued by ONC. BioIngine platform 100 can immensely drive the adoption of interoperability advancing “pay for performance” by complex organizations like Accountable Care Organizations; by introducing algorithmic driven approach that is inherently bio-statistical in approach. BioIngine platform 100 is suited for addressing large complex systemic design, such as, where the system behavior (e.g. as with inherent business rules) is automatically discovered by machine learning. The traditional design requires deterministically designing the system by physically imposing the design constraints to represent the business rules. When a medical system contains thousands of rules, this is impractical to physically capture and impose such rules. Especially when the rules are probabilistic and tend to change over time.

Additionally, it Is noted that an HDN is a general graph, bidirectional and with cycles, while a Bayes Net is by definition a Directed Acyclic Graph. The BioIngine platform approach is not confined to conditional probabilities, that are simply only IF (though AND can appear in a BN, as in P(A|B, C)=P(A IF B AND C)). It can use relators based on the Dirac Notation idea of the bra-operator-ket as a semantic triple. A HDN via its mechanism for Inference can evolve under syllogistic reasoning, etc.

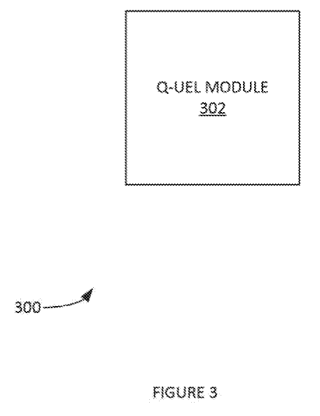

FIG. 3 illustrates an example Quantum Exchange Language (QEXL) approach 300, according to some embodiments. Approach 300 can include three interdependent components. Q-UEL module 302 can include both probabilistic inference method and Phenomenon-Of-Interest. Q_UEL module 302 can addresses global issues that potentially pervade all human endeavors, and hence universal interoperability is of key importance.

In one example embodiment, approach 300 can implement QEXL Approach can enable an architecturally Probabilistic Inference (PI) and a Data Architecture for the Inference Engine (IE) to be cooperative. Software robots can be created while the PI and IE interact. The inference knowledge gained by the PI and IE provide rules for solvers (e.g. the software robots) to self-compile and conduct queries etc.

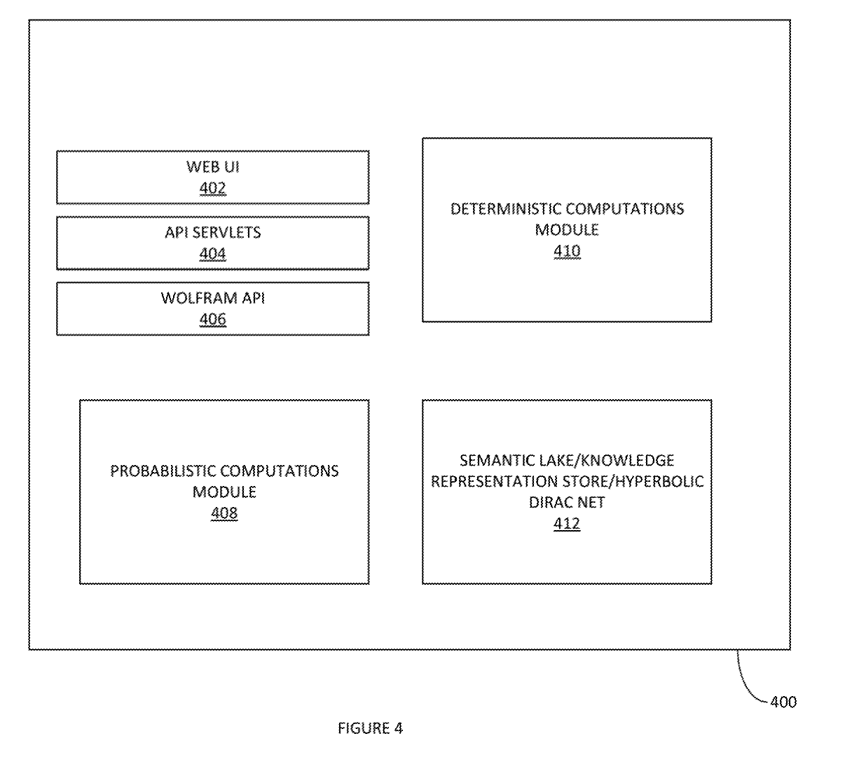

FIG. 4 illustrates an example inference engine 400, according to some embodiments. Inference engine 400 can include a Software-As-a-Service Layer. This can deliver a comprehensive automated statistical capability that blends both deterministic and probabilistic methods (e.g. based on Q-UEL/HDN). This capability implement semantic reasoning delivering MARPLE. In some example, the Q-UEL machinery delivering MARPLE can be developed into a Wolfram Language® taking advantage of the Symbolic Programming, thus better and thus the Notational Algebra that underlies Q-UEL. Wolfram Enterprise Private Cloud® can be implemented as a Platform-As-a-Service Layer. Wolfram Enterprise Private Cloud (WEPC) takes the unique benefits of the Wolfram technology stack and makes them available In a centralized, private, secure enterprise solution. WEPC can enables organizations to realize an enterprise computation strategy.

The Inference knowledge gained by inference engine 400 can provide rules for solvers (e.g. software robots, etc.) to self-compile and conduct queries etc. The software robots can be designed and programmed to do the remaining coding required to perform as solvers. The software robots can be provided with well-formed instructions as well as well-formed queries.

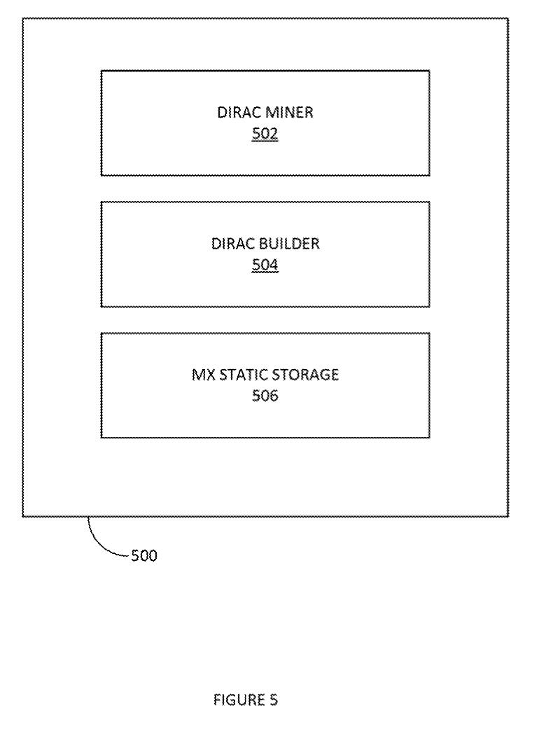

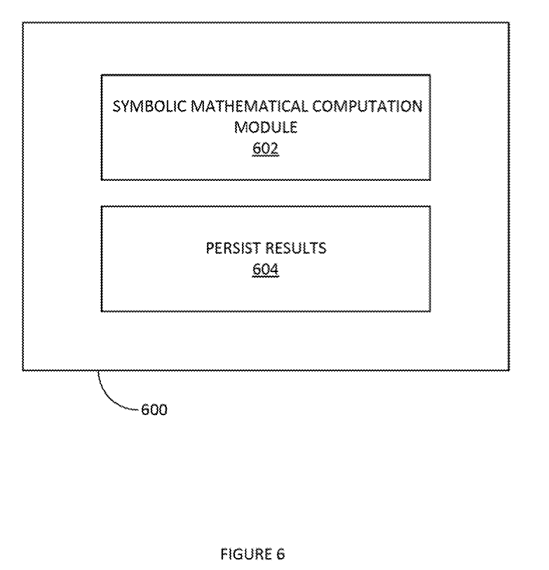

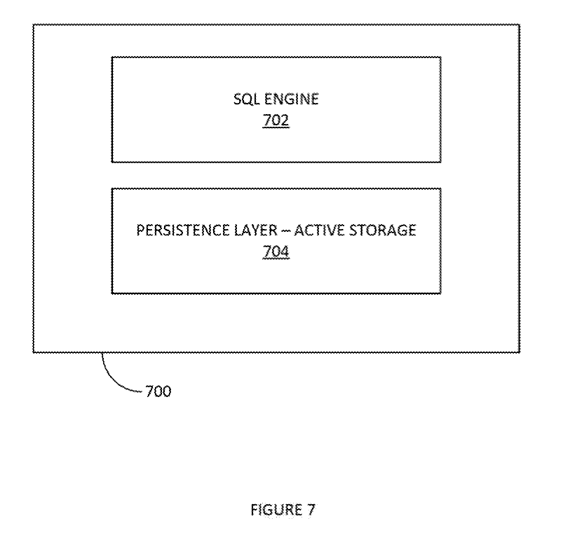

More specifically, in some examples, inference engine 400 can include web user interface (UI) 402, API servlets 404 and Wolfram® API 406. These can be implemented in a cloud-computing platform. Inference engine 400 can include a probabilistic computations module 408. Probabilistic computations module 408 can include a Dirac builder, Dirac miner, Dirac-xtractor, POPPER and/or MX-Static to Active Dynamically Scaling Storage (see FIG. 5 infra). Inference engine 400 can include a deterministic computations module 410. Deterministic computations module 410 can include persist libraries and a mathematical computation functionality (e.g. Mathematica® libraries, etc.). Additional information about deterministic computations module 410 is provided infra in FIG. 6. Inference engine 400 can include semantic lake/knowledge representation store/hyperbolic Dirac net 412. Semantic lake/knowledge representation store/hyperbolic Dirac net 412 can Include an SQL engine and a persistence layer that provides active storage. Additional information about semantic lake/knowledge representation store/hyperbolic Dirac net 412 is provided infra in FIG. 7.

FIG. 5 illustrates an example probabilistic computations module 500, according to some embodiments. Probabilistic computations module 500 can include a Dirac builder 504, Dirac miner 502 and MX-Static to Active Dynamically Scaling Storage 506.

FIG. 6 illustrates an example deterministic computations module 600, according to some embodiments. Deterministic computations module 600 can include persist libraries 604 and a mathematical computation functionality 602 (e.g. Mathematica® libraries, etc.

FIG. 7 illustrates an example Semantic lake/knowledge representation store/hyperbolic Dirac net 700, according to some embodiments. Semantic lake/knowledge representation store/hyperbolic Dirac net 700 can include an SQL engine 702 and a persistence layer 704. Persistence layer 704 can provide active storage.

Additional Example Computing Systems

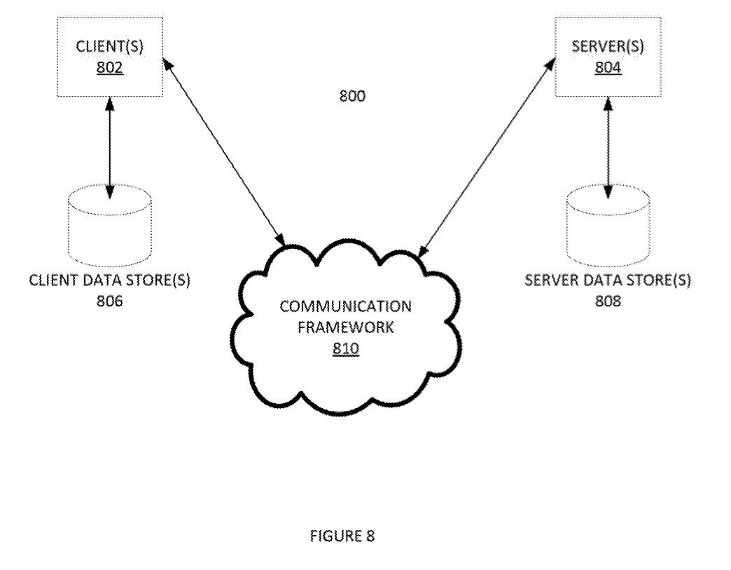

FIG. 8 is a block diagram of a sample-computing environment 800 that can be utilized to implement various embodiments. The system 800 further illustrates a system that includes one or more client(s) 802. The client(s) 802 can be hardware and/or software (e.g., threads, processes, computing devices). The system 800 also includes one or more server(s) 804. The server(s) 804 can also be hardware and/or software (e.g., threads, processes, computing devices). One possible communication between a client 802 and a server 804 may be in the form of a data packet adapted to be transmitted between two or more computer processes. The system 800 includes a communication framework 810 that can be employed to facilitate communications between the client(s) 802 and the server(s) 804. The client(s) 802 are connected to one or more client data store(s) 806 that can be employed to store information local to the client(s) 802. Similarly, the server(s) 804 are connected to one or more server data store(s) 808 that can be employed to store information local to the server(s) 804. In some embodiments, system 800 can instead be a collection of remote computing services constituting a cloud-computing platform.

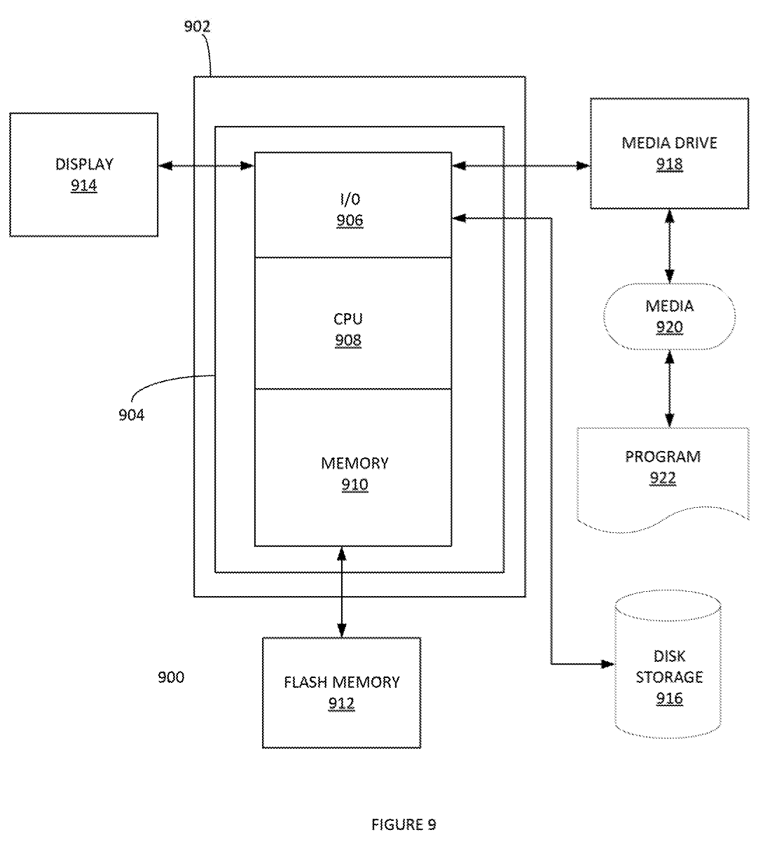

FIG. 9 depicts an exemplary computing system 900 that can be configured to perform any one of the processes provided herein. In this context, computing system 900 may include, for example, a processor, memory, storage, and I/O devices (e.g., monitor, keyboard, disk drive, Internet connection, etc.). However, computing system 900 may include circuitry or other specialized hardware for carrying out some or all aspects of the processes. In some operational settings, computing system 900 may be configured as a system that includes one or more units, each of which is configured to carry out some aspects of the processes either in software, hardware, or some combination thereof.

FIG. 9 depicts computing system 900 with a number of components that may be used to perform any of the processes described herein. The main system 902 includes a motherboard 904 having an I/O section 906, one or more central processing units (CPU) 908, and a memory section 910, which may have a flash memory card 912 related to it. The I/O section 906 can be connected to a display 914, a keyboard and/or other user input (not shown), a disk storage unit 916, and a media drive unit 918. The media drive unit 918 can read/write a computer-readable medium 920, which can contain programs 922 and/or data. Computing system 900 can include a web browser. Moreover, it is noted that computing system 900 can be configured to include additional systems in order to fulfill various functionalities. Computing system 900 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

A Dirac-ingine module can implement data mining based a set of non-predicated machine learning operations that is further based on Quantum-Universal Exchange Language (Q-UEL) to generate a hyperbolic Dirac nets (HDN).

A Dirac-ingine module can use a machine-learning tool to employ a Dirac notation (Notational Algebra) to extract a knowledge set from a data set by combination of quantitative and qualitative computations, wherein the knowledge set comprises extracted medical knowledge represented in terms of semantic triples or multiples;

A Dirac-ingine module can apply the quantitative and qualitative computations based data mining method against structured, unstructured and restructured data sources.

A Dirac-ingine module can have following sub-modules. MARPLE is an overarching capability as result of all the following modules.

A Dirac-ingine module's Structured Data Mining based on quantitative probabilistic computations feature is implemented by Dirac-Miner. Dirac Miner is primarily concerned with providing tags as probabilistic statements of knowledge as input to the hyperbolic Dirac Net (HDN) referred to below, and/or to POPPER referred to below, POPPER being a special kind of HDN extended to probabilistic semantics in general.

DiracMiner is compatible with and makes use of a Universal Exchange Language Q-UEL, an XML-like extension for healthcare and biomedicine

A Dirac-ingine module's Structured Data Mining based on quantitative probabilistic computations feature is implemented by Dirac-Miner. Structured Data Mining implies a form of sampling and counting based on the assumption that the abundances of various features in the data, and their distribution into separate records (e.g. medical records) if any, relates meaningfully to probabilities out there in the world. In contrast to simple EBM measures, the probabilities can be about the relationship between many demographic and clinical factors. Unsupervised (unfocused) data mining implies high-dimensional data mining and a combinatorial explosion to consider.

Q-UEL uses DiracMiner, that takes different approaches to managing this key problem, and managing sparse data that arises as a further consequence. Inference Net-Driven Structured Data Mining is a form of supervised structured data mining. The user constructs a rough, preliminary, interim, or initial inference net. In Q-UEL this is an HDN expressed in terms Q-UEL tags as bidirectional probabilities (duals). DiracBuilder looks automatically for relevant knowledge elements in the KRS, and use them to assign the relevant probabilities. Those found are typically, but not necessarily, those generated by DiracMiner.

DiracBuilder (Dirac-inference tool) a Dirac-ingine module that implements an HDN-based probabilistic inference mechanism from the knowledge set and locates any missing statements and paths that connect said statements such that the statements can be represented in an HDN-format;

XTRACTOR:—a Dirac-ingine module's Unstructured data mining based on qualitative probabilistic computations is implemented by XTRACTOR Data Mining from Unstructured Data based on qualitative probabilistic computations. A XTRACTOR module that implement an unsupervised-unstructured web searching tool to generate one or more statements of knowledge, wherein the one or more statements of knowledge are extracted from the knowledge set.

A Dirac-ingine module's Unstructured data mining based on qualitative probabilistic computations is implemented by XTRACTOR. Unstructured data mining implies the automatic searching of the Internet and analysis of authoritative natural language text that it processes to obtain knowledge elements to add to the KRS. The primary knowledge extraction method is XTRACTOR, an automatic browser. The MARPLE “multiple-choice medical school exam” method employs XTRACTOR to test and curate knowledge so gathered, much as one tests a student, and is essentially the use of elaborate kinds of query and machine learning. The method is subject to the anecdotal effect: the number of Internet hits relates more to newsworthiness and interest than to probabilities intrinsic to statements about the world that are based on counting as in structured data mining. However, this is bypassed by focus on so-called contextual probabilities, relating to relevance, that dominates. The challenge of acting like a robot physician might seem relatively easy for Q-UEL because this approach works well for multiple-choice medical examinations when MARPLE is appropriately trained. However, to reach that point by machine learning, curation of KRS elements by a human expert is still required to a significant extent. Moreover, compared with such exam situations, medical practice and EBM are far more open systems. There is no fixed syllabus, it cannot be guaranteed that any question is answerable, there may not be a small set of plausible candidate answers, and rudimentary or “presyllogistic” logic may no longer suffice. This is less serious in practice because healthcare and government authorities look positively upon a degree of intervention by expert humans. Indeed, they would doubtless feel very uncomfortable if physicians and health workers were to unequivocally accept the unsupervised judgment of the computer, and if the knowledge used were not subjected to authentication or validation by human experts, including curating the knowledge elements. Nonetheless, structured and unstructured mining techniques are capable of adding hundreds of thousands or more of knowledge elements the KRS in a day. The human curator obviously needs as much help with checking, testing and correcting the knowledge as it is possible to get from automation.

Restructured data mining is a Q-UEL term. It seeks diminish the anecdotal effect of extracting knowledge from text on the Web in order to obtain estimates of intrinsic probabilities, in effect more judicious subjective probabilities, when structured data is not available, because EBM and its PICO like probabilities and measures of them based on counting whenever possible. The term might seem better replaced by counter-anecdotal adjustment or confirmation bias elimination, or even simply retro- or pseudo-structured data mining, because correction is applied to the results of unstructured data mining to assign better possibilities, not the structure of the source data (although arguably KRS elements are restructured as to probability values). It may be considered and loaded as a separate module, but was early thought of as a novel mode of use of the BioIngine, requiring introduction only of an additional file. Before that, it was an interactive process buried in the normal work of the human end-user amongst many other interactive processes. At that earliest stage, it was discovered that the counts of hits on the Internet by MARPLE tend to be internally renormalized in the natural course of attempts to express PICO-based probability ratios. Importantly also, one can compare numbers of hits for P and I compared with those for P and C only for those webpages in which the outcome implied in the source text is essentially or close to the desired outcome O and not, for example, associated because they are alerting medical contraindications for use of a drug. The additional file was one of content (words and phrases) that would avoid use of knowledge from such sources (or conversely focus on such web sites if such knowledge is wanted.) The file is a further addition to the set of files called buzzwords, badwords, and synonyms which encourage the serach procedure to direct attention to, or avoid, certain types of content. The approach is also extensible to the probabilistic semantic HDN with verbal and other relationships. There one may compare one such HDN concerned with intervention I and another concerned with comparison C, (as well sometimes as with favorable and unfavorable outcomes), even after evolving by the action of metastatements that apply e.g. syllogistic laws.

POPPER:—a Dirac-ingine module's simple programming language for probabilistic semantic inference in medicine is POPPER. It is seen in part as a tool (a) to convert Q-UEL tags to a form that makes simpler the building of inference networks and the inference engines that drive them, and, importantly, (b) as an interface by which a medical expert can construct Q-UEL tags (when data mining to obtain probabilistic information is not an easy option).

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, t can be appreciated that the various operations, processes, and methods disclosed herein can be embodied in a machine-readable medium and/or a machine accessible medium compatible with a data processing system (e.g., a computer system), and can be performed in any order (e.g., Including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized system of a BioIngine platform for implementing a Medical Automated Reasoning Programming Language Environment (MARPLE) comprising:
a Dirac-ingine module that implements a set of non-predicated machine learning operations to generate a hyperbolic Dirac nets (HDN);
a Dirac-miner module that uses a machine-learning tool to employ a Dirac notation to extract a knowledge set from a data set, wherein the knowledge set comprises extracted medical knowledge represented in terms of semantic triples or multiples;
a Dirac-inference tool module that implements an HDN-based inference mechanism from the knowledge set and locates any missing statements and paths that connect said statements such that the statements can be represented in an HDN-format; and
a Dirac-extractor module that implement an unsupervised-unstructured web searching tool to generate one or more statements of knowledge, wherein the one or more statements of knowledge are extracted from the knowledge set.

2. The computerized system of claim 1, wherein the Dirac-ingine module uses Dirac notation.

3. The computerized system of claim 2, wherein the Dirac notation comprises a bra-ket notation.

4. The computerized system of claim 2, wherein the Dirac-ingine module employs a Quantum-Universal Exchange Language.

5. The computerized system of claim 4, wherein the Dirac-ingine module implements the set of non-predicated machine learning operations to generate the hyperbolic Dirac nets as a general graph.

6. The computerized system of claim 4, wherein the HDN comprises a Bayes network.

7. The computerized system of claim 6, wherein the Bayes network comprises a directed acyclic graph option as a subset.

8. The computerized system of claim 7, wherein the Dirac-data miner uses a supervised machine learning tool.

9. The computerized system of claim 7, wherein the Dirac-data miner extracts the knowledge set as a semantic-triple store.

10. The computerized system of claim 9, wherein the semantic-triple store is represented as an HDN graphs that is placed in a knowledge representation store (KRS).

11. The computerized system of claim 10, wherein Dirac-inference tool module scans the HDN based semantic triple store and the KRS.
